(19) United States
(12) Patent Application Publication
(10) Pub. No.: US 2010/0213230 A1
(43) Pub. Date: Aug. 26, 2010

(54) FILM DISPENSER CASE AND CASE WITH FILM

(76) Inventors: Asako Saakl, Osaka (JP); Mitsuru Yanagisawa, Ibaraki (JP); Tadashi Umetsu, Tokyo (JP)

Correspondence Address: REED SMITH LLP, P.O. BOX 488, PITTSBURGH, PA, 15230-0488, US

(21) Appl. No.: 12/599,521

(22) PCT Filed: Apr. 21, 2008
(86) PCT No.: PCT/JP2008/057662

§ 371 Date: Nov. 10, 2009

(30) Foreign Application Priority Data
May 11, 2007 (JP) 2007-126977

(51) Int. Cl. B26F 3/02

(52) U.S. Cl. 225/39

(57) ABSTRACT

To provide a film dispenser case which allows a cutting member to be easily, safely, and completely separated from a box, and a case with the film. A film dispenser case 10 comprises a box body 12, a rectangular lid board, a cover lid piece and a cutting member. The box body 12 can contain a film winding body 1 which is formed of film 2 being wound. The box body 12 has a rectangular bottom board 14, a front board 16, a rear board 18 and two side boards 20. The box body 12 opens one face 26. The lid board 30 has a hinge side 60 and a folded side 62 opposed to the hinge side. The lid board 30 connects to the rear board on the hinge side to be rotatable about the hinge side, and covers the face opened. The cover lid piece 32 connects to the lid board on the folded side. The cover lid piece is formed into a substantially rectangular shape by the folded side, a front end edge side 64 opposed to the folded side, and two lateral sides 66. The cutting member 50 is for cutting the film. The cutting member is disposed in a strip shape along the front end edge side and, is fixed to the cover lid piece at fixing portions 78 distributed in the longitudinal direction of the stripe-shaped of the cutting member. Each of cut lines 70 and 72 is formed on the cover lid piece, and the cut line extends from the lateral side through between the fixing portions and the folded side and then leads to the front end edge side.

### TECHNICAL FIELD

This invention relates to a film dispenser case for containing a film winding body which is formed by winding a length of film and for cutting the film to a desired length for use, and the case with the film. More particularly, this invention relates to a film dispenser case which allows a cutting member to be easily separated from the case after the film is used up, and the case with the film.

### BACKGROUND ART

Generally, a film to be used for wrapping food and other articles, such as a synthetic resin wrapping film, an aluminum foil, and a kitchen paper sheet, is contained in a film dispenser case for sale. The film dispenser case contains the film in a rectangular-parallelepiped paper box body. The box body has an opening, and a lid board designed to cover the opening connects to the box body, so that the lid board freely opens or closes the opening of the box body. A cover lid piece, which overlaps a front board of the box body, connects to a front end edge of the lid board. A metal cutting member is fixed to a front end edge of the cover lid piece and on the backside thereof, such that the sawtooth edge of the cutting member slightly protrudes from the cover lid piece. The cutting member is used to cut the film to a desired length for use. After the film is used-up, to dispose or to recycle the film dispenser case, removal of the cutting member from the cover lid piece is required because the cutting member is made of metal. However, the cutting member has the sawtooth. Thus, picking the cutting member with fingers involves a risk of hurting the fingers. Therefore, the adopted solution to this problem is to form perforations on the cover lid piece to help easily separate and remove a part of the cover lid piece on which the cutting member is fixed (see Patent Document 1). [Patent Document 1] JP-B-2627139

### DISCLOSURE OF INVENTION

### Problem to be Solved by the Invention

The cutting member is separated together with a small piece of paper that is a separated part of the cover lid piece. An object of this invention is therefore to provide a film dispenser case which allow the cutting member to be easily, safely, and completely separated from the box, and the case with the film.

### Means for Solving the Problem

To achieve the above object, according to aspect (1) of the present invention, as shown in FIGS. 1 and 2, for example, A film dispenser case comprises a box body 12 to contain a film winding body 1 which is formed of film 2 being wound, the box body 12 having a rectangular bottom board 14, a front board 16, a rear board 18 and two side boards 20, the front board 16, the rear board 18, and the two side boards 20 standing upright from four respective sides of the bottom board 14, and opening one face 26; a rectangular lid board 30 having a hinge side 60 and a folded side 62 opposed to the hinge side 60, the lid board 30 connecting to the rear board 18 on the hinge side 60 to be rotatable about the hinge side 60, and covering the face 26 opened; a cover lid piece 32 connecting to the lid board 30 on the folded side 62, the cover lid piece 32 being formed into a substantially rectangular shape by the folded side 62, a front end edge side 64 opposed to the folded side 62, and two lateral sides 66; and a cutting member 50 for cutting the film 2, the cutting member 50 being disposed in a strip shape along the front end edge side 64 and being fixed to the cover lid piece 32 at fixing portions 78 distributed in the longitudinal direction of the stripe-shaped of the cutting member 50; wherein a series of cut lines 70 and 72 is formed on the cover lid piece 32, and the series of cut lines 70 and 72 extends from the lateral side 66 through between the fixing portions 78 and the folded side 62 and then leads to the front end edge side 64. The wording “the cover lid piece being formed into a substantially rectangular shape” includes the case where a front end edge side 64 is not formed into a straight line, but formed into a V-shape or an arch shape.

In accordance with the above construction, the series of cut lines is formed on the cover lid piece, and the series of cut lines extends from the lateral side through between fixing portions and the folded side and then leads to the front end edge side. Thus, a part of the cover lid piece is cut off and removed along the cut line, thereby exposing a part of the cutting member. The exposed part of the cutting member is used as a starting point to separate the cutting member from the cover lid piece. This allows the cutting member to be easily and completely separated from the cover lid piece.

According to aspect (2) of the present invention, as shown in FIG. 4, for example, the film dispenser case according to aspect (1) may comprise an attaching piece 36 connecting to the cover lid piece 32, the attaching piece 36 connecting to a part of the lateral side 66 between the series of cut lines 70 and 72 and the front end edge side 64.

In accordance with the above construction, a part of the lid cover piece is cut off and removed along the cut line by picking and pulling the attaching piece, and thus, a part of the cutting member is exposed easily.

According to aspect (3) of the present invention, as shown in FIGS. 1 and 2, for example, the film dispenser case according to aspect (2) may comprise a side lid piece 34 connecting to a sideward side 68 of the lid board 30, the sideward side 68 linking the hinge side 60 to the folded side 62; wherein the lid board 30 and the cover lid piece 32 may be folded along the folded side 62 at a substantially right angle, and the attaching piece 36 may be fixed to the side lid piece 34.

In accordance with the above construction, the lid board and the cover lid piece are folded at a substantially right angle, and the attaching piece and a side lid piece are fixed to each other. This construction stabilizes the folded form of the lid board and the cover lid piece, and thus allows the film to be easily cut off by the cutting member fixed along the front end edge side of the cover lid piece.

According to aspect (4) of the present invention, as shown in FIG. 1, for example, in the film dispenser case according to any one of aspect (1) to aspect (3), the cutting member 50 may be made of metal and may be staking-fixed to the cover lid piece 32.

In accordance with the above construction, the cutting member is staking-fixed to the cover lid piece. This allows the cutting member to be easily and completely separated from the cover lid piece.

According to aspect (5) of the present invention, as shown in FIG. 1, for example, a case with film comprises the film dispenser case 10 according to any one of aspect (1) to aspect (4); and the film winding body 1 contained in the box body 12.

In accordance with the above construction, the case with film, in which the cutting member is easily and completely separated from the cover lid piece, is provided.

This application is based on the Patent Applications No. 2007-126977 filed on May 11, 2007 in Japan, the contents of which are hereby incorporated in its entirety by reference into the present application, as part thereof.

The present invention will become more fully understood from the detailed description given hereinbelow. Further range of application of the present invention will become more clear from the detailed description given hereinbelow. However, the detailed description and the specific embodiment are illustrated of desired embodiments of the present invention and are described only for the purpose of explanation. Various changes and modifications will be apparent to those ordinary skilled in the art on the basis of the detailed description.

The applicant has no intention to give to public any disclosed embodiment. Among the disclosed changes and modifications, those which may not literally fall within the scope of the patent claims constitute, therefore, apart of the present invention in the sense of doctrine of equivalents.

The use of the terms “a” and “an” and “the” and similar referents in the context of describing the invention (especially in the context of the following claims) are to be construed to cover both the singular and the plural, unless otherwise indicated herein or clearly contradicted by context. The use of any and all examples, or exemplary language (e.g., “such as”) provided herein, is intended merely to better illuminate the invention and does not pose a limitation on the scope of the invention unless otherwise claimed.

### EFFECT OF THE INVENTION

In accordance with the present invention, a film dispenser case comprises a box body to contain a film winding body which is formed of film being wound, the box body having a rectangular bottom board, a front board, a rear board and two side boards, the front board, the rear board, and the two side boards standing upright from four respective sides of the bottom board, and opening one face; a rectangular lid board having a hinge side and a folded side opposed to the hinge side, the lid board connecting to the rear board on the hinge side to be rotatable about the hinge side, and covering the face opened; a cover lid piece connecting to the lid board on the folded side, the cover lid piece being formed into a substantially rectangular shape by the folded side, a front end edge side opposed to the folded side, and two lateral sides; and a cutting member for cutting the film, the cutting member being disposed in a strip shape along the front end edge side and being fixed to the cover lid piece at fixing portions distributed in the longitudinal direction of the stripe-shaped of the cutting member; wherein a cut line is formed on the cover lid piece, and the cut line extends from the lateral side through between the fixing portions and the folded side and then leads to the front end edge side. Thus, a part of the cover lid piece is cut off and removed along the cut line, thereby exposing a part of the cutting member. The exposed part of the cutting member is used as a starting point to separate the cutting member from the cover lid piece. This allows the cutting member to be easily and completely separated from the cover lid piece. As a result, the film dispenser case which allows the cutting member to be easily, safely, and completely separated from the box, and the case with the film can be provided.

In accordance with the present invention, A case with film comprises the film dispenser case described above and the film winding body contained in the box body. Thus, it is a case with film in which the cutting member is easily and completely separated from the cover lid piece. As a result, the case with film which allows the cutting member to be easily, safely, and completely separated from the box can be provided.

### BRIEF DESCRIPTION OF DRAWINGS

FIG. 1 is a perspective view illustrating a case with a length of film;

FIG. 2 is a developed view of a film dispenser case to be assembled;

FIG. 3 is a developed view of the used film dispenser case;

FIG. 4 is a developed view of the film dispenser case with its attaching piece picked up;

FIG. 5 is a developed view of the film dispenser case with its separate portion torn off;

FIG. 6 is a developed view of the film dispenser case with its separate portion torn off and with its cutting member upper side; and

FIG. 7 is a developed view of the film dispenser case with its cutting member pulled up so as to fold the cutting member toward the direction where the cutting member is still fixed to the cover lid piece.

### DESCRIPTION OF REFERENCE NUMERALS AND SYMBOLS

1: film winding body
2: film
10: film dispenser case
12: box body
14: bottom board
16: front board
18: rear board
20: side board
26: open face
30: lid board
32: cover lid piece
34: side lid piece
36: attaching piece
38: separate portion
40: tear-off piece
42: bonding piece
44: bonding piece
50: cutting member
60: hinge side
62: folded side
64: front end edge side
66: lateral side
68: sideward side
70: first cut line
72: second cut line
76: tear-off line
78: fixing portion
100: case with film

### BEST MODE FOR CARRYING OUT THE INVENTION

Embodiments of the present invention will be hereinafter described in reference to the appended drawings. In the drawings, the same or like components are provided with the same or like reference numerals and symbols, without duplicate description.

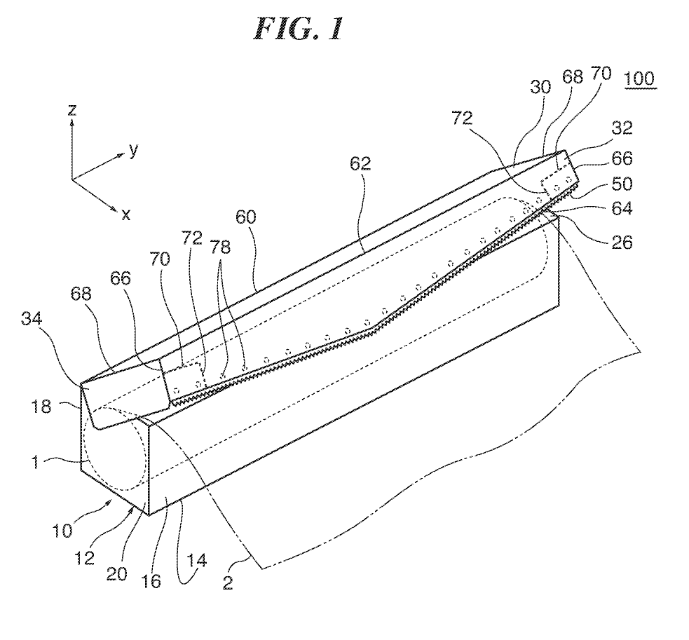

With reference to FIG. 1, a case with film 100 according to the embodiment of the invention will be described below. FIG. 1 is a perspective view illustrating the case with film 100. The case with film 100 has a film winding body 1, which is formed by winding a length of film, in a film dispenser case 10. FIG. 1 shows the film winding body 1 contained in the film dispenser case 10 by a broken line, and shows the film 2 part of which is pulled out of the film dispenser case 10 by a chain double-dashed line. The film 2 is not limited to a specific film, but may be a synthetic resin wrapping film, an aluminum foil, a kitchen paper sheet or any other type of film. The long-form film 2 is wound on a cylindrical core (not shown), forming the film winding body 1. The film winding body 1 is contained in the film dispenser case 10. The film 2 is pulled out of the film dispenser case 10 to be cut to a desired length for various uses.

The film dispenser case 10 comprises a box body 12, a lid board 30 rotatably connected to the box body 12, a cover lid piece 32 connected to the lid board 30 and a cutting member 50 fixed to the cover lid piece 32. The box body 12 is a rectangular parallelepiped having one open face 26. In the box body 12 shown in FIG. 1, a bottom face opposed to the open face 26 is referred to as a bottom board 14, a frontward face is referred to as a front board 16, a face opposed to the front board 16 is referred to as a rear board 18, and two side faces connecting the front board 16 to the rear board 18 are referred to as side boards 20. The box body 12 is an elongated rectangular parallelepiped. The box body 12 has the length in the longitudinal direction “y” slightly greater than an axial length of the cylindrical film winding body 1, and has the length in the width direction “x” and the height “z” both slightly greater than the outside diameter of the film winding body 1. The box body 12 thus contains the film winding body 1 therein. As a greater length of the film 2 is used, the outside diameter of the film winding body 1 is smaller. This increases a clearance between the film winding body 1 and the box body 12 both in the width direction x and in the height z.

The lid board 30 connects to a top side of the rear board 18 of the box body 12 or a hinge side 60, such that the lid board 30 is rotatable about the hinge side 60. The lid board 30 is substantially as large as or slightly larger than the open face 26, so that the lid board 30 covers the open face 26. The cover lid piece 32 connects to the folded side 62 of the lid board 30, which is opposed to the hinge side of the lid board 30. The other two sides of the lid board 30, which link the hinge side 60 to the folded side 62, are sideward sides 68. Side lid pieces 34 connect respectively to the sideward sides 68.

A front end edge of the cover lid piece 32, that is, a front end edge side 64 opposed to the folded side 62 is formed into a V-shape having a vertex at the center of the front end edge side 64. The front end edge side 64 may be formed into a straight line parallel to or oblique to the folded side 62, or may be formed into an arch shape or any type of curve. Any shape is acceptable for the distal end side 64. In any of the cases, the shape of the cover lid piece 32 falls under the category of substantially rectangular shape.

Along the front end edge side 64 of the cover lid piece 32, a cutting member 50 is fixed to the backside of the cover lid piece 32 or the side thereof which faces the box body 12. The cutting member 50 is a strip-shaped member extending along the front end edge side 64. The strip-shaped cutting member 50 has longitudinal sawtooth formed on its edge. The cutting member 50 is disposed such that the sawtooth slightly protrude from the front end edge side 64. The strip-shaped cutting member 50 is fixed to the cover lid piece 32 at fixing portions 78 distributed in the longitudinal direction of the cutting member 50. In FIG. 1, a plurality of circled portions, which are distributed along the front end edge side 64, represent the fixing portions 78. The fixing portions are distributed in the longitudinal direction of the strip-shaped cutting member 50, so that the whole of the strip-shaped cutting member 50 is stably fixed to the cover lid piece 32.

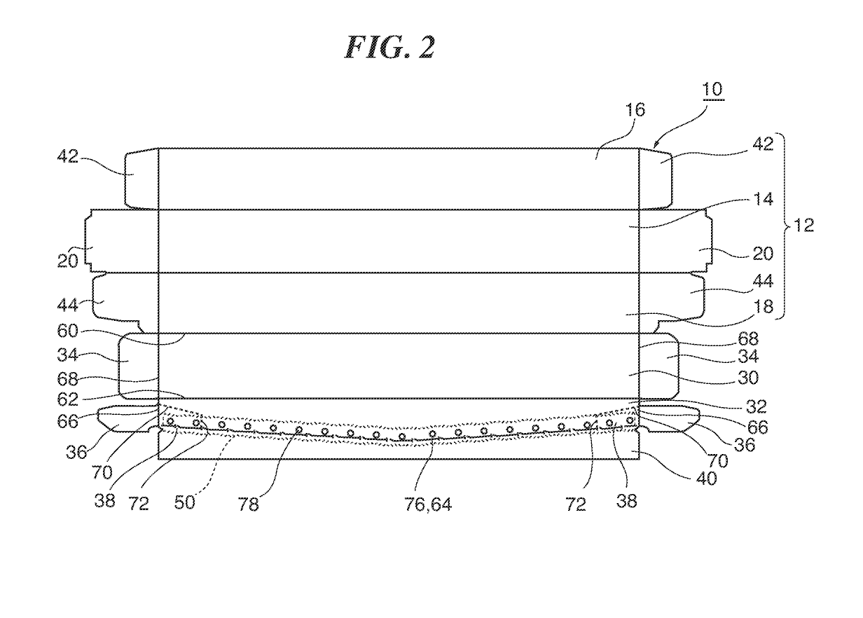

With reference to FIG. 2, described is the assembly of the film dispenser case 10. FIG. 2 is a developed view of the film dispenser case 10 to be assembled. Typically, the box body 12, the lid board 30, the cover lid piece 32, the side lid piece 34, and so forth are made of paper. Therefore, a blank, which is stamped out of a sheet of paper and has folding lines as shown by the developed view of FIG. 2, is used for the film dispenser case 10. The film dispenser case 10 is assembled by folding the blank along the folding lines and bonding. The front board 16, the bottom board 14, the rear board 18, the lid board 30, and the cover lid piece 32 are aligned, connecting to each other with a folding line located between the two adjacent pieces. A tear-off piece 40 connects to the front end edge side 64 (see FIG. 1) of the cover lid piece 32. More specifically, the cover lid piece 32 and the tear-off piece 40 form a piece of board having a long perforated part or a tear-off line 76 along the shape of the front end edge side 64. Thus, the front board 16, the bottom board 14, the rear board 18, the lid board 30, the cover lid piece 32, and the tear-off piece 40 form a substantially rectangular shape.

Bonding pieces 42 connect respectively to the opposite sides of the front board 16 with a folding line located between each bonding piece 42 and the front board 16. The sideboards 20 connect respectively to the opposite sides of the bottom board 14 with a folding line located between each side board 20 and the bottom board 14. Bonding pieces 44 connect respectively to the opposite sides of the rear board 18 with a folding line located between each bonding piece 44 and the rear board 18. The side lid pieces 34 connect respectively to the opposite sides of the lid board 30 with a folding line located between each side lid piece 34 and the lid board 30. Attaching pieces 36 connect respectively to the opposite sides of the cover lid piece 32 with a folding line located between each attaching piece 36 and the cover lid piece 32.

The cutting member 50 is fixed to the backside of the cover lid piece 32. Typically, the cutting member 50 is made from a metal sheet, and is staking-fixed to the cover lid piece 32. For example, cylindrical projections are formed from the metal sheet. The cylindrical projections are pressed onto the cover lid piece 32, and then bent at the ends of the projections, thereby fixing the cutting member 50 to the cover lid piece 32. Such staking-fixing is performed easily using no adhesive or other attachment, because the projections are formed concurrently with press-stamping a metal sheet blank into the cutting member 50, and are pressed on the backside of the paper blank for the film dispenser case 10. In this case, a staked part of each projection at its distal end, which is bent digging into the cover lid piece 32, is formed smaller than the other part. In other words, the staked part comes off the cover lid piece 32 easily. The wording “backside” represents an inside face when the film dispenser case 10 is assembled. FIG. 2 is a developed view of the film dispenser case 10 viewed from its outside. Thus, each of the folding lines in FIG. 2 is to be a mountain fold.

First cut lines 70 which are perforated are formed on the cover lid piece 32. The first cut lines 70 extend respectively from lateral sides 66 that correspond to the folded lines located between the attaching piece 36 and the cover lid piece 32. Each first cut line 70 extends from the lateral side 66 along the strip-shaped cutting member 50 and runs through between the fixing portions 78 and the folded side 62. The wording “between the fixing portions 78 and the folded side 62” indicates an area between the folded side 62 and a hypothetical line (using linear approximation). The hypothetical line is drawn by connecting a plurality of the fixing portions 78, which are distributed in the longitudinal direction of the stripe-shaped cutting member 50, to the lateral sides 66. On the cover lid piece 32, second cut lines 72 are derived from the first cut lines 70, respectively. Each second cut line 72 crosses over the line connecting the fixing portions 78, to which the cutting member 50 is fixed, and leads to the front end edge side 64. Thus, the first cut line 70 and the second cut line 72 extend in individual directions to intersect each other, and connect together at the intersection. Each attaching piece 36 connects to a part of the cover lid piece 32 between the tear-off line 76, which corresponds to the front end edge side 64, and the first cut line 70.

The first cut line 70 and the second cut line 72 do not necessarily form an L-shape shown in FIG. 2. For example, a T-shape may be alternatively formed such that the second cut line 72 intersects with a midway part of the first cut line 70. Further alternatively, a π-shape may be formed such that the first cut lines 70 extending from the opposite lateral sides 66 of the cover lid piece 32 are individually elongated until the first cut lines 70 meet each other to form a single line. Still further alternatively, the first cut line 70 and the second cut line 72 may have no specific separation therebetween, and may curve and connect to each other, looking as if a single cut line is formed. Still further alternatively, the first cut line 70 and the second cut line 72 may form a straight line extending from the lateral side 66 through between the fixing portions 78 and the folded side 62, and leading to the tear-off line 76 corresponding to the front end edge side 64. That is, such a straight line is oblique to the tear-off line 76. The first cut lines 70 and the second cut lines 72 are not necessarily perforated, but may be half-cutoff lines or full-cutoff lines, or otherwise may take any form that allows for easy tear-off. Generally, the paper blank to be used is composed of layers of thin paper sheets. Therefore, the wording “half-cutoff” indicates that the layers of thin paper sheets are not entirely, but partly cut off. Also, the wording “full-cutoff” indicates that all the layers of thin paper sheets are cut off. Even when the first cut lines 70 and the second cut lines 72 are full-cutoff lines, each separate portion 38 defined by the first cut line 70, the second cut line 72, and the tear-off line 76 (the front end edge side 64) is secured to the cutting member 50. In addition, the tear-off line 76 is not a full-cutoff line, and therefore, the separate portion 38 is not separated from the other portion of the cover lid piece 32.

In order to assemble the film dispenser case 10 from the blank of FIG. 2, the blank is folded along the respective folding lines at an approximately right angle, and the side board 20 and the bonding pieces 42 and 44 are overlapped with the side board 20 located outermost, and then bonded together. The side board 20 and the bonding pieces 42 and 44 are bonded together in such a manner, thus to form the box body 12 with the front board 16, the rear board 18, and the two side boards 20 all standing upright from the four respective sides of the bottom board 14. In addition, the side lid piece 34 and the attaching piece 36 are overlapped with the side lid piece 34 located outer, and then bonded together. The side lid piece 34 and the attaching piece 36 are bonded together in such a manner, thus to stabilize the form of the lid board 30 and the cover lid piece 32 which connect at a right angle. In short, the lid board 30, the cover lid piece 32, and the side lid pieces 34 are held respectively at a right angle to each other. The side board 20 and the bonding pieces 42 and 44 are not bonded to the side lid piece 34 or the attaching piece 36. This enables the lid board 30 to rotate around the hinge side 60 as a rotational axis with respect to the box body 12.

Returning to FIG. 1, described is the way of using the case with film 100. While the lid board 30 is opened with the open face 26 exposed, the film winding body 1 is put into the box body 12. Then, the lid board 30 is closed to cover the open face 26. Generally, the case with film 100 becomes commercially available at this stage. To prevent the film winding body 1 from slipping out of the film dispenser case 10 during transportation, the tear-off piece 40 (see FIG. 2) may be slightly bonded to the front board 16 with an adhesive, for example. Prior to using the film 2, a user pulls one end of the tear-off piece 40, thereby to cut the perforations of the tear-off line 76 (see FIG. 2) sequentially remove the tear-off piece 40. When the tear-off piece 40 is removed, the sawtooth of the cutting member 50 slightly protrude from the front end edge side 64 of the cover lid piece 32.

The film 2 wound as the film winding body 1 is pulled out of the film dispenser case 10 through the lid board 30 and through between the cover lid piece 32 and the front board 16. When the film 2 is pulled out to a desired length, the cover lid piece 32 is pressed against the front board 16, and simultaneously, the film 2 is pulled upward to be lifted above the lid board 30. Thus, the film 2 abuts against the sawtooth of the cutting member 50 so firmly that the film 2 is cut off. The attaching piece 36 and the side lid piece 34 are bonded together, thus to stabilize the form of the lid board 30 and the cover lid piece 32. Therefore, even when the film 2 abuts against the cutting member 50 firmly, the cover lid piece 32, more specifically, the cutting member 50 is prevented from deformation. Thus, the film 2 is cut off easily. In the aforementioned manner, the long-form film 2 wound as the film winding body 1 is cut off to a desired length for use.

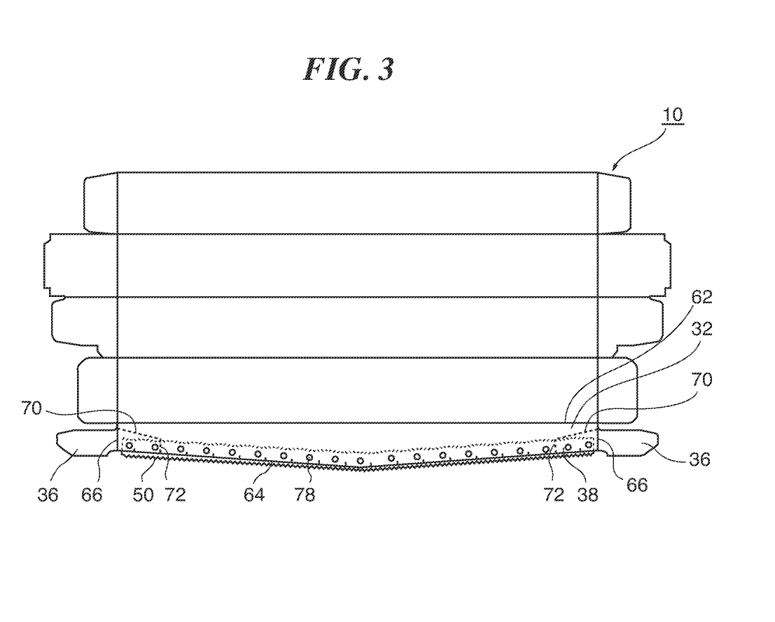

Now, with reference to FIGS. 3 to 7, described is the disassembly of the used film dispenser case 10. FIG. 3 is a developed view of the used film dispenser case 10. When the whole film 2 is used up, the core used for the film winding body 1 is removed from the box body 12. Then, the side board 20 and the bonding pieces 42 and 44, which have been bonded together, are unstuck from each other. Also, the side lid piece 34 and the attaching piece 36, which have been bonded together, are unstuck from each other. Then, as shown by the developed view of FIG. 3, the film dispenser case 10 is unfolded into one piece of sheet. The used film dispenser case 10 is different from the film dispenser case 10 to be assembled shown in FIG. 2 in that the tear-off piece 40 (see FIG. 2) is torn off.

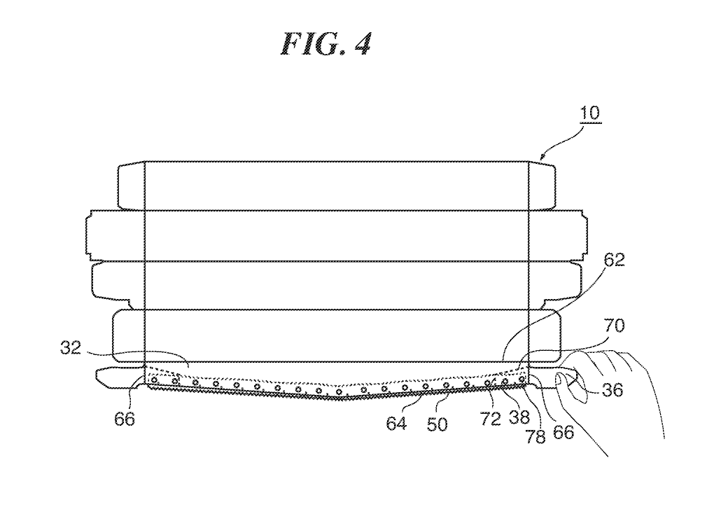

Subsequently, as shown in FIG. 4, the unfolded film dispenser case 10 is placed on the table or the like with its outside surface appearing or with the cutting member 50 located underside. FIG. 4 is a developed view of the film dispenser case 10 with the attaching piece 36 picked up. The attaching piece 36 is picked up with either hand, while the other part of the film dispenser case 10 is held with the other hand. Then, the attaching piece 36 is pulled up. The attaching piece 36 connects to the cover lid piece 32 with the lateral side 66 located therebetween, and therefore, the cover lid piece 32 is pulled together with the attaching piece 36. More specifically, the attaching piece 36 connects to a part of the cover lid piece 32 between the front end edge side 64 and the first cut line 70. Thus, a part of the lateral side 66 between the front end edge side 64 and the first cut line 70 is pulled up. This results in a force exerted on the first cut line 70, cutting the perforations. Alternatively, the attaching piece 36 may partly connect, on the lateral side 66, to a part of the cover lid piece 32 between the first cut line 70 and the folded side 62. In this case, when the length, by which the attaching piece 36 connects to a part of the cover lid piece 32 between the front end edge side 64 and the first cut line 70, is greater than the length, by which the attaching piece 36 connects to a part of the cover lid piece 32 between the first cut line 70 and the folded side 62, a greater proportion of the force exerted on the attaching piece 36 is applied between the front end edge side 64 and the first cut line 70. This results in a force exerted on the first cut line 70, cutting the perforations. As described above, while the attaching piece 36 connects to a part of the cover lid piece 32 not only between the front end edge side 64 and the first cut line 70, but also between the first cut line 70 and the folded side 62, the length, by which the attaching piece 36 connects to a part of the cover lid piece 32 between the front end edge side 64 and the first cut line 70, is greater than the length, by which the attaching piece 36 connects to a part of the cover lid piece 32 between the first cut line 70 and the folded side 62. This state is also included in the concept that the attaching piece 36 connects to a part of the lateral side 66 between the first cut line 70 and the front end edge side 64.

The perforations of the first cut line 70 are cut, and then the attaching piece 36 is further held upward, thus to cut the perforations of the second cut line 72. Especially, while being held upward, the attaching piece 36 is pulled toward the front end edge side 64, so that the perforations of the second cut line 72 are cut more reliably. As a consequence of cutting the perforations of the second cut line 72, the separate portion 38, defined by the first cut line 70, the second cut line 72, and the distal end side 64, is torn off from the other portion of the cover lid piece 32. At the same time, the separate portion 38 is also separated from the cutting member 50. As the cutting member 50 is staking-fixed to the cover lid piece 32, more specifically, to the separate portion 38, the separate portion 38 is tidily separated from the cutting member 50. Especially, in the case where a staked part of each projection at its end, which is bent digging into the cover lid piece 32, is formed smaller than the other part of the projection, the staked part easily comes off the cover lid piece 32 and the separate portion 38 is easily and tidily separated from the cutting member 50. In addition, in the case where the staked parts of the projections or the fixing portions 78 are distributed in the longitudinal direction of the cutting member 50, preferably only one or two of the fixing portions 78 are arranged in the separate portion 38, for example. This helps the staked parts easily come off the separate portion 38, thus separating the separate portion 38 from the cutting member 50.

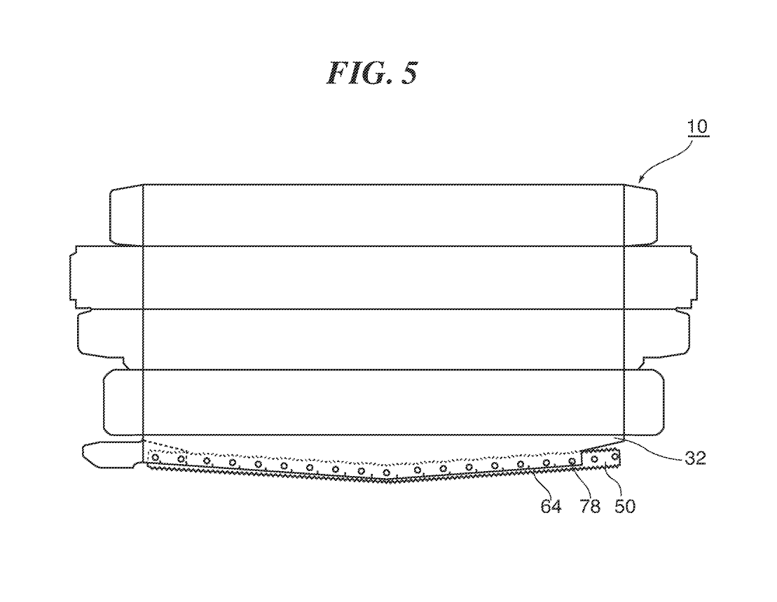

As shown in FIG. 5, a part of the cutting member 50, where the separate portion 38 is torn off, is exposed. FIG. 5 is a developed view of the film dispenser case 10 with the separate portion 38 torn off. As shown in FIG. 5, when the part of the cutting member 50 is exposed, a user is likely to pick, not the sawtooth portion of the cutting member 50, but a flat width center portion of the cutting member 50. This allows a user to easily and safely pick the cutting member 50 alone with his/her hand.

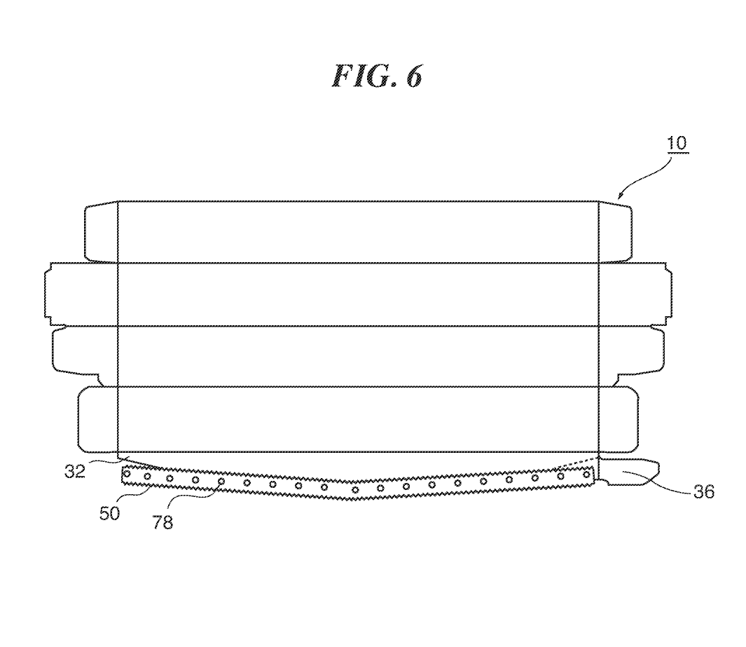

As shown in FIG. 6, a sheet of the film dispenser case 10 is turned upside down, such that the cutting member 50 is located upper side. FIG. 6 is a developed view of the film dispenser case 10 with the separate portion 38 torn off and with the cutting member 50 located upper side. While the exposed part of the cutting member 50 is picked with either hand, the sheet of the film dispenser case 10 is held with the other hand, thereby to gradually pull up the cutting member 50 from one side. Then, the majority of the force used to pull up the cutting member 50 is applied to one of the fixing portions 78. Thus, the staked part comes off the cover lid piece 32, and therefore, the cutting member 50 is gradually separated from the cover lid piece 32.

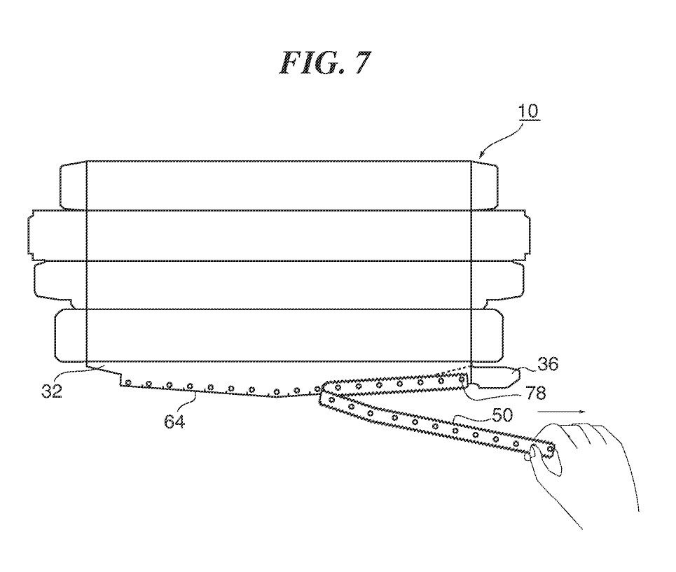

Furthermore, as shown in FIG. 7, the cutting member 50 is pulled up so as to fold it toward the direction where the cutting member 50 is still fixed to the cover lid piece 32 (the arrow direction in FIG. 7). This allows the staked parts to more easily come off the cover lid piece 32. FIG. 7 is a developed view of the film dispenser case 10 with the cutting member 50 pulled up so as to fold the cutting member 50 toward the direction where the cutting member 50 is still fixed to the cover lid piece 32. In such a manner as shown in FIG. 7, the cutting member 50 is separated from the box easily, safely, and completely. Thus, an incombustible metal material or the cutting member 50 can be separated from the paper box, allowing for easy waste disposal or paper recycling process.

In the aforementioned description of the embodiment of the invention, the cutting member 50 is made of metal, but may be made of plastic, ceramic, or any other material. In addition, in the aforementioned description, the cutting member 50 is staking-fixed to the cover lid piece 32, but may be fixed by another known method, such as bonding with an adhesive.

1. A film dispenser case comprising:
a box body to contain a film winding body which is formed of film being wound, the box body having a rectangular bottom board, a front board, a rear board and two side boards, the front board, the rear board, and the two side boards standing upright from four respective sides of the bottom board, and opening one face;
a rectangular lid board having a hinge side and a folded side opposed to the hinge side, the lid board connecting to the rear board on the hinge side to be rotatable about the hinge side, and covering the face opened;
a cover lid piece connecting to the lid board on the folded side, the cover lid piece being formed into a substantially rectangular shape by the folded side, a front end edge side opposed to the folded side, and two lateral sides; and
a cutting member for cutting the film, the cutting member being disposed in a strip shape along the front end edge side and being fixed to the cover lid piece at fixing portions distributed in the longitudinal direction of the stripe-shaped of the cutting member;
wherein a cut line is formed on the cover lid piece, and the cut line extends from the lateral side through between the fixing portions and the folded side and then leads to the front end edge side.

2. The film dispenser case as recited in claim 1, further comprising: an attaching piece connecting to the cover lid piece, the attaching piece connecting to a part of the lateral side between the cut line and the front end edge side.

3. The film dispenser case as recited in claim 2, further comprising: a side lid piece connecting to a sideward side of the lid board, the sideward side linking the hinge side to the folded side;
wherein the lid board and the cover lid piece are folded along the folded side at a substantially right angle, and the attaching piece is fixed to the side lid piece.

4. The film dispenser case as recited in claim 1, wherein the cutting member is made of metal and is staking-fixed to the cover lid piece.

5. A case with film comprising:
the film dispenser case as recited in claim 1; and
the film winding body contained in the box body.

6. The film dispenser case as recited in claim 2, wherein the cutting member is made of metal and is staking-fixed to the cover lid piece.

7. The film dispenser case as recited in claim 3, wherein the cutting member is made of metal and is staking-fixed to the cover lid piece.

8. A case with film comprising:
the film dispenser case as recited in claim 2; and
the film winding body contained in the box body.

9. A case with film comprising:
the film dispenser case as recited in claim 3; and
the film winding body contained in the box body.

10. A case with film comprising:
the film dispenser case as recited in claim 4; and
the film winding body contained in the box body.

11. A case with film comprising:
the film dispenser case as recited in claim 6; and
the film winding body contained in the box body.

12. A case with film comprising:
the film dispenser case as recited in claim 7; and
the film winding body contained in the box body.
